(19) United States
(12) Patent Application Publication
(10) Pub. No.: US 2010/0087143 A1
(43) Pub. Date: Apr. 8, 2010

(54) WIRELESS POWER AND DATA TRANSFER VIA CAPACITIVE COUPLING

(75) Inventor: Wayne Allen Bonin, North Oaks, MN (US)

Correspondence Address: Fellers, Snider, Blankenship, Bailey & Tippens, PC;(Seagate Technology LLC), 100 North Broadway, Suite 1700, Oklahoma City, OK, 73102-8820, US

(73) Assignee: SEAGATE TECHNOLOGY LLC, Scotts Valley, CA (US)

(21) Appl. No.: 12/245,460

(22) Filed: Oct. 3, 2008

(51) Int. Cl. H04B 5/00; H02M 7/04

(52) U.S. Cl. 455/41.1; 363/37

(57) ABSTRACT

A method and system for wirelessly transferring data and power via capacitive coupling. In some embodiments, a plurality of first electrodes is configured to wirelessly transfer power and data signals through an insulating layer to a plurality of second electrodes with capacitive coupling. In some embodiments, the insulating layer comprises at least a dielectric film.

### BACKGROUND

Electronic devices generally operate to retrieve and relay data in a reliable and efficient manner. Some electric devices utilize wireless transmission of data and power. However, large losses of signal strength during wireless communications have generally made wireless power and data transmission unfavorable replacements for traditional wired electronic signal transmission.

As will be appreciated, electronic devices heavily rely on the transmission of power and data signals to operate in the current culture that includes a wide variety of mobile electronic devices.

In these and other types of electronic devices, it is often desirable to increase efficiency and accuracy of data and power transmission, particularly with regard to wireless transmissions in mobile electronic devices.

### SUMMARY

Various embodiments of the present invention are generally directed to a method and system for wirelessly transmitting data and power via capacitive coupling.

In accordance with various embodiments, a plurality of first electrodes is configured to wirelessly transfer power and data signals through an insulating layer to a plurality of second electrodes with capacitive coupling.

In other embodiments, a dielectric film is used as the insulating layer to facilitate wireless transmission of power and data as well as improve capacitive coupling.

These and various other features and advantages which characterize the various embodiments of the present invention can be understood in view of the following detailed discussion and the accompanying drawings.

### BRIEF DESCRIPTION OF THE DRAWINGS

FIG. 1 is a general illustration of an exemplary wireless transmission structure constructed and operated in accordance with various embodiments of the present invention.

FIG. 2 shows an alternative exemplary wireless transmission structure constructed and operated in accordance with various embodiments of the present invention.

FIG. 3 displays an alternative embodiment of a wireless transmission structure constructed and operated in accordance with various embodiments of the present invention.

FIG. 4 generally illustrates an exemplary environment capable of a plurality of wireless transmissions in accordance with the various embodiments of the present invention.

FIG. 5 displays a flow diagram of a wireless transmission operation in accordance with the various embodiments of the present invention.

### DETAILED DESCRIPTION

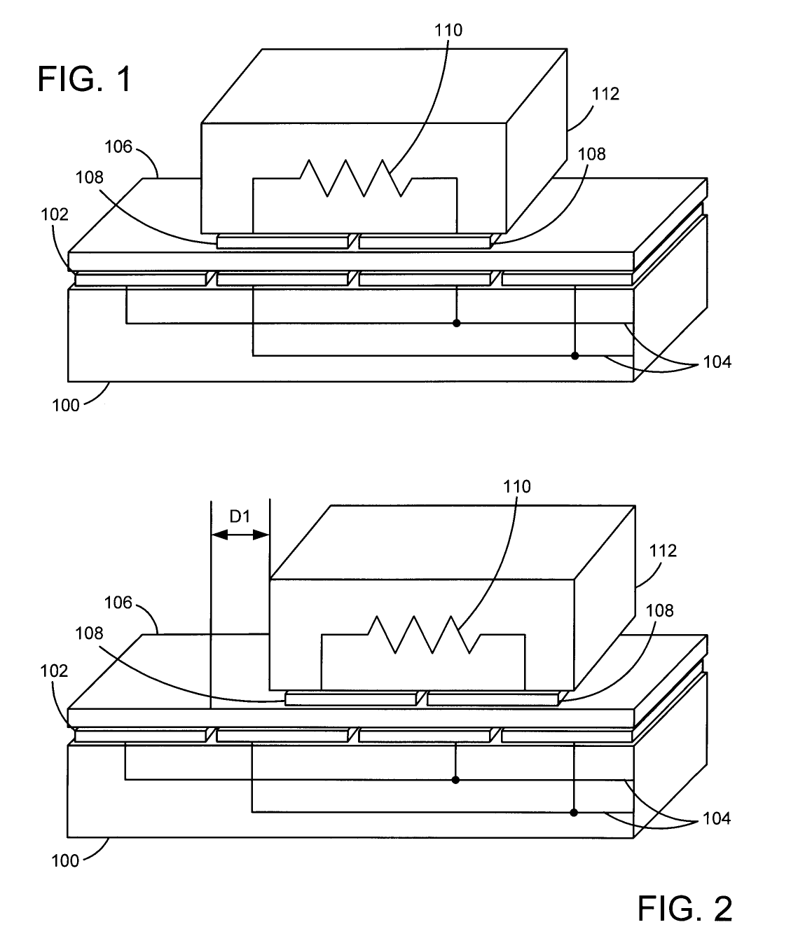

FIG. 1 generally illustrates an embodiment of the present invention capable of wirelessly transferring power and data. A bottom plane 100 has a plurality of bottom electrodes 102 connected to a source through wired connections 104. The plurality of bottom electrodes 102, in this embodiment, are along a common plane, but the bottom electrodes 102 can be placed on various slopes including, but not limited to, perpendicular surfaces. In addition, the bottom electrodes 102 are covered at least partially by an insulating layer 106. The insulating layer 106 provides an electrical insulation for the bottom electrodes 102 as well as providing an electrical conduit to which wireless signals such as power and data can be efficiently transferred with capacitive coupling.

A plurality of top electrodes 108 are coupled to the insulating layer 106 and are configured to receive data and power signals. The top electrodes 108 are also electrically connected to a load 110 positioned in an electrical device 112. It should be noted that the electrical device 112 can be a variety of devices including, but not limited to, mobile devices such as laptop computers, cellular phones, or music players. Alternatively, the electrical device 112 can be a device capable of receiving data such as, but not limited to, televisions, telephones, and desktop computers.

Although electrodes 102 and 108 are described as top and bottom electrodes, any appropriate orientation of electrodes are with the scope of the various embodiments of the present invention. Top and bottom electrodes are terms used for simplicity in this description.

A general illustration of a misaligned wireless transmission structure is shown in FIG. 2. The bottom plane 100 has bottom electrodes 102 that are spaced at a distance D1 that allows the top electrodes 108 to not properly align. The misalignment of the top and bottom electrodes 102 and 108 can result in a non-optimal transfer of power or data signals through the insulating layer 106.

A disadvantage of misaligned electrodes is the loss of signal strength of power or data signals either individually or in combination. The loss of signal strength would result in inefficient operation of the electrical device 112.

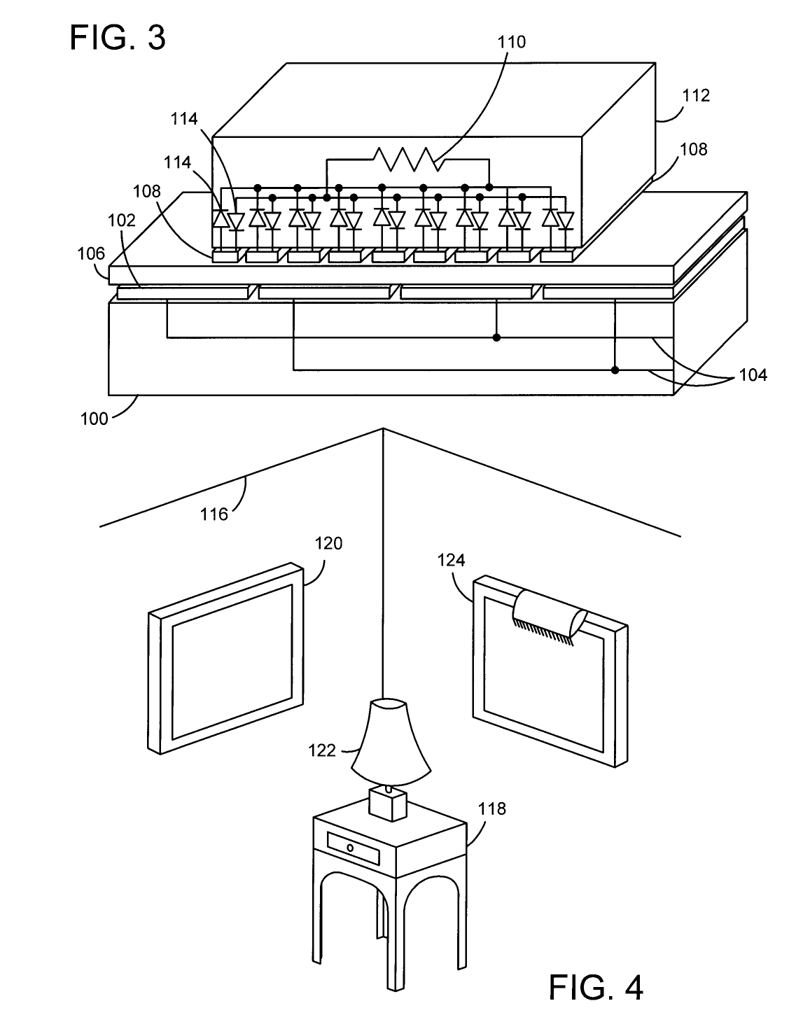

An alternative embodiment of a wireless transmission structure is displayed in FIG. 3. A bottom plane 100 is shown with bottom electrodes 102 connected to a host device with wired connections 104. An insulating layer 106 at least partially covers the bottom electrodes 102. The electrical device 112 has at least one load 110 that is connected to a plurality of top electrodes 108. As more top electrodes 108 are implemented in the electrical device 112 with smaller physical size along a common surface of the electrical device 112, a higher probability of proper alignment and a lower likelihood of misalignment is created when the number of top electrodes 108 exceeds the number of bottom electrodes 102.

In addition, a smaller top electrode 108 size results in more electrode surface area to be active and a stronger signal to be wirelessly transferred reliably. However, a number of diodes 114 are used to regulate the direction of signals to and from the load 110. The diodes can be a variety of types including, but not limited to, Zener, Schottky, and Esaki diodes.

FIG. 4 generally displays an exemplary environment capable of wirelessly transmitting power and data in accordance with various embodiments of the present invention. A number of surfaces can be configured to allow wireless transfer of data and power signals such as a wall 116 or table 118. An electrical device such as a television 120 can be installed on the wall 116 so that top electrodes (108 of FIGS. 1-3) are adjacent to the bottom electrodes (102 of FIGS. 1-3) and the insulating layer (104 of FIGS. 1-3) of the surface. A wireless transmission of both power and data signals can be accomplished by placing a high frequency modulated carrier signal on the power signal.

While power and data signals are wirelessly transmitted to one electrical device on a surface such as a wall 116, a second electrical device can receive power and data signals on the same surface or a different surface, such as a table 118. An electrical device such as a lamp 122 can be coupled to an insulating layer (104 of FIGS. 1-3) of a surface such as a table 118 that has a plurality of bottom electrodes (102 of FIGS. 1-3) installed. It can be appreciated that any surface can have electrodes and an insulating layer installed on the entire surface or an isolated portion of the surface. For example, a wall 116 can have bottom electrodes and an insulating layer installed on only a small portion of the surface so that power and data can flow to an electrical device such as a lighted picture frame 124.

It can further be appreciated that individual power or data signals can be wirelessly transmitted to a single or multiple electronic devices. In other words, placement of multiple electronic devices on a surface that has bottom electrodes and an insulating layer installed allows for one device to wirelessly receive data and power signals while a second electronic device receives only power signals wirelessly.

Further, the wireless transfer of data and power signals is accomplished through capacitive coupling. The capacitance as seen from the bottom surface (100 of FIGS. 1-3) decreases dramatically as the electrical device is removed. The current required to drive the bottom electrodes decreases when the load and electrical device no longer are adjacent to the insulating layer. This makes the capacitive system much more practical and energy efficient as opposed to conventional inductive power transmission.

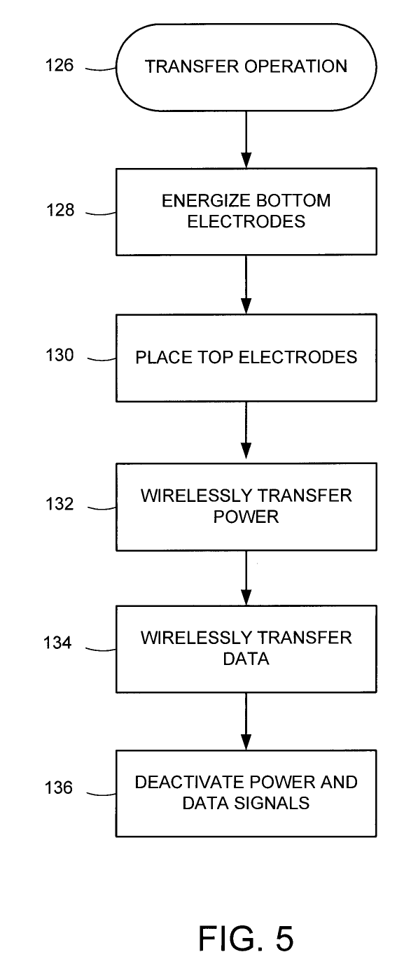

FIG. 5 displays a flow diagram of a transfer operation 126 conducted in accordance with the various embodiments of the present invention. The transfer operation 126 initially energizes the bottom electrodes (102 of FIGS. 1-3) at step 128. A plurality of top electrodes is placed on the insulating surface at step 130. However, step 130 can be skipped if an electrical device with a plurality of top electrodes is already adjacent to the insulating layer. Once the top and bottom electrodes are adjacent to the insulating layer, step 132 wirelessly transfers power to the top electrodes with capacitive coupling to activate the electrical device. Subsequently in step 134, data signals are capacitively coupled wirelessly from the bottom electrodes to the top electrodes. Finally, the data and power signals are deactivated in step 136.

As can be appreciated by one skilled in the art, the various embodiments illustrated herein provide advantages in wireless transmission efficiency and compatibility. The ability to energize a portion of a surface or the entire surface to transmit power or data signals individually or in combination simultaneously allows for a more simple and reliable system. Moreover, the wireless transfer of power and data signals to virtually any electrical device provides vast compatibility that can service both mobile and stationary electrical devices. The utilization of capacitive coupling to wirelessly transfer signals provides energy savings as well as strong wireless signals needed to power modem electronics. However, it will be appreciated that the various embodiments discussed herein have numerous potential applications and are not limited to a certain field of electronic media or type of data storage devices.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. A wireless transfer system comprising;
a plurality of first electrodes connected to a load;
a plurality of second electrodes connected to a source;
an insulating layer at least partially covering the electrodes, wherein the plurality of second electrodes are configured to wirelessly transfer power signals and data signals through the insulating layer to the plurality of first electrodes via capacitive coupling.

2. The system of claim 1, wherein the insulating layer is a dielectric film.

3. The system of claim 1, wherein the current required to drive at least one electrode on a common surface decreases when a load is removed.

4. The system of claim 1, wherein a plurality of electrodes are placed on a common plane of an electronic device.

5. The system of claim 4, wherein the electronic device is a mobile device.

6. The system of claim 1, wherein the number of electrodes on a first common plane exceed the number of electrodes on a common opposing plane.

7. The system of claim 6, wherein the in plane size of the electrodes on the first common plane are smaller than the in plane size of the electrodes on the common opposing plane.

8. The system of claim 1, wherein data is transferred through the insulating layer by placing a modulated carrier signal on a power signal.

9. The system of claim 7, wherein the modulated signal is of a high frequency.

10. The system of claim 1, wherein the power and data signals are transferred when a plurality of first electrodes are positioned adjacent to the insulating layer.

11. The system of claim 1, wherein each first electrode is connected to at least two diodes.

12. A method comprising:
coupling a plurality of top electrodes to an insulating layer; and
transferring a power signal and a data signal from a plurality of bottom electrodes to the top electrodes through the insulating layer wirelessly via capacitive coupling.

13. The method of claim 12, wherein the insulating layer is a dielectric film.

14. The method of claim 12, wherein the current required to drive at least one electrode on a common surface decreases when a load is removed.

15. The method of claim 12, wherein a plurality of electrodes are placed on a common plane of an electronic device.

16. The method of claim 12, wherein the number of electrodes on a first common plane exceed the number of electrodes on a common opposing plane.

17. The method of claim 16, wherein the in plane size of the electrodes on the first common plane are smaller than the in plane size of the electrodes on the common opposing plane.

18. The method of claim 12, wherein data is transferred through the insulating layer by placing a modulated carrier signal on a power signal.

19. The method of claim 18, wherein the modulated signal is of a high frequency.

20. The method of claim 12, wherein the power and data signals are transferred when the plurality of top electrodes are positioned adjacent to the insulating layer.

21. The system of claim 12, wherein each top electrode is connected to at least two diodes.
